(19) United States
(12) Patent Application Publication
(10) Pub. No.: US 2009/0104364 A1
(43) Pub. Date: Apr. 23, 2009

(54) NON-WELDABLE COATING COMPOSITIONS EXHIBITING CORROSION RESISTANCE PROPERTIES

(75) Inventors: Edward R. Millero, JR., Gibsonia, PA (US); Carole A. Conley, Verona, PA (US); Jeffrey L. Stalker, Wexford, PA (US); Guillaume Fascella, Maresches (FR)

Correspondence Address: PPG INDUSTRIES INC;INTELLECTUAL PROPERTY DEPT, ONE PPG PLACE, PITTSBURGH, PA, 15272, US

(73) Assignee: PPG INDUSTRIES OHIO, INC., Cleveland, OH (US)

(21) Appl. No.: 11/873,755

(22) Filed: Oct. 17, 2007

(51) Int. Cl. C08K 3/02; B05D 3/00; C08L 33/10

(52) U.S. Cl. 427/387; 524/442; 524/556; 524/601

(57) ABSTRACT

Disclosed are coating compositions exhibiting corrosion resistance properties. These compositions include (a) a film-forming binder; (b) a particulate material consisting essentially of elemental silicon; and (c) a non-conductive filler. The coating compositions are non-weldable.

### FIELD OF THE INVENTION

The present invention is directed to non-weldable coating compositions exhibiting corrosion resistance properties.

### BACKGROUND OF THE INVENTION

Coatings are often applied by roller application using contrarotating rolls to metal coils (strips or long sheets), such as galvanized steel coils or aluminum coils. Since the processing of the metal does not take place until after the coating is applied, the coatings must have extremely good mechanical integrity, such as flexibility. Coated coils are often used in the architectural sector for producing ceiling and wall elements, doors, pipe insulations, roller shutters or window profiles, building sidewall panels and roofing panels, in the vehicle sector for producing paneling for caravans or truck bodies, and in the household sector for producing profile elements for washing machines, dishwashers, freezers, refrigerators, and ranges, among other items.

In many cases, a “primer” coating layer is applied to a coil to protect a metal substrate from corrosion. The primer layer is often applied directly to a bare or pretreated metallic substrate. In some cases, particularly where the primer layer is to be applied over a bare metallic substrate, the primer layer is deposited from a composition that includes a material, such as an acid, such as phosphoric acid, which enhances the adhesion of the primer layer to the substrate.

Historically, corrosion resistant “primer” coatings have utilized chromium compounds and/or other heavy metals, such as lead, to achieve a desired level of corrosion resistance and adhesion to subsequently applied coatings. The use of chromium and/or other heavy metals, however, results in the production of waste streams that pose environmental concerns and disposal issues.

More recently, efforts have been made to reduce or eliminate the use of chromium and/or other heavy metals. As a result, coating compositions have been developed that contain other materials added to inhibit corrosion. These materials have included, for example, zinc phosphate, iron phosphate, zinc molybdate, and calcium molybdate particles, among others. These materials, however, can, in at least some cases, negatively impact upon the flexibility of the resulting coating, which can be particularly undesirable in coil coating applications.

As a result, it would be desirable to provide coating compositions that are substantially free of chromium and/or other heavy metals, wherein the compositions can exhibit favorable corrosion resistance properties. In addition, it would be desirable to provide such a coating composition that is suitable for use in a coil coating application in which the resulting coating must be flexible but need not be weldable.

### SUMMARY OF THE INVENTION

In certain respects, the present invention is directed to coating compositions that comprise: (a) a film-forming binder; (b) a particulate material consisting essentially of elemental silicon; and (c) a non-conductive filler. These coating compositions of the present invention are non-weldable.

In other respects, the present invention is directed to methods for coating a substrate, such as a metal substrate. These methods of the present invention comprise: (a) depositing onto at least a portion of the substrate a coating composition comprising: (i) a film-forming binder; (ii) a particulate material consisting essentially of elemental silicon; and (iii) a non-conductive filler; and (b) curing the composition to form a cured non-weldable coating having a dry film thickness of greater than 2.2 microns.

The present invention is also directed to related coated substrates.

### DETAILED DESCRIPTION OF EMBODIMENTS OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

As previously indicated, in certain embodiments, the coating compositions of the present invention comprise a film-forming binder. As used herein, the term “film-forming binder” refers to binders that can form a self-supporting continuous film on at least a horizontal surface of a substrate upon removal of any diluents or carriers present in the composition or upon curing at ambient or elevated temperature. As used herein, the term “binder” refers to a continuous material in which the particulate material consisting essentially of elemental silicon and the non-conductive filler (which are described below) are dispersed.

In certain embodiments, the film-forming binder is polymeric. As used herein, the term “polymer” is meant to encompass oligomers, and includes, without limitation, both homopolymers and copolymers.

Polymeric film-forming binders that are suitable for use in the compositions described herein include thermoplastic or thermosetting materials. In certain embodiments, the film-forming binder included within the coating compositions of the present invention comprises a thermosetting film-forming resin. As used herein, the term “thermosetting” refers to resins that “set” irreversibly upon curing or crosslinking, wherein the polymer chains of the polymeric components are joined together by covalent bonds. This property is usually associated with a cross-linking reaction of the composition constituents often induced, for example, by heat or radiation. See Hawley, Gessner G., The Condensed Chemical Dictionary, Ninth Edition., page 856; Surface Coatings, vol. 2, Oil and Colour Chemists' Association, Australia, TAFE Educational Books (1974). Curing or crosslinking reactions also may be carried out under ambient conditions. Once cured or crosslinked, a thermosetting resin will not melt upon the application of heat and is insoluble in solvents. In other embodiments, the film-forming binder included within the coating compositions of the present invention comprises a thermoplastic resin. As used herein, the term “thermoplastic” refers to resins that comprise polymeric components that are not joined by covalent bonds and thereby can undergo liquid flow upon heating and are soluble in solvents. See Saunders, K. J., Organic Polymer Chemistry, pp. 41-42, Chapman and Hall, London (1973).

Thermosetting film-forming resins suitable for use in the coating compositions of the present invention include both self-crosslinking resins and external crosslinking resins. As used herein, the term “self-crosslinking resin” refers to resins that contain reactive functional groups that are capable of undergoing crosslinking reactions with groups of their own kind, i.e., themselves, or with complementary functional groups. As used herein, the term “external crosslinking resin” refers to resins that contain reactive functional groups that are capable of undergoing crosslinking reactions with complementary functional groups that are present on a crosslinking agent, i.e., resins formed from the reaction of a polymer having at least one type of reactive group and a crosslinking agent having reactive groups reactive with the reactive group(s) of the polymer.

In certain embodiments, the film-forming binder present in the coating compositions of the present invention comprises a polymer selected from the group consisting of random, alternating, and block, linear, branched, and comb addition (co)polymers of ethylenically unsaturated monomer or oligomers, polyaddition resins and/or polycondensation resin that are curable physically, thermally, under ambient conditions, with actinic radiation (such as near infrared, electron beam, and ultraviolet radiation), and/or both thermally and with actinic radiation.

Polymers suitable for use in the present invention include, for example, acrylic, saturated or unsaturated polyester, polyurethane or polyether, polyvinyl, cellulosic, acrylate, silicon-based polymers (which are considered “organic” for purposes of the present invention), co-polymers thereof, and mixtures thereof, and can contain reactive groups such as epoxy, carboxylic acid, hydroxyl, isocyanate, amide, carbamate and carboxylate groups, among others, including mixtures thereof.

Suitable acrylic polymers include, for example, those described in United States Patent Application Publication 2003/0158316 A1 at [0030]-[0039], the cited portion of which being incorporated herein by reference. Suitable polyester polymers include, for example, those described in United States Patent Application Publication 2003/0158316 A1 at [0040]-[0046], the cited portion of which being incorporated herein by reference. Suitable polyurethane polymers include, for example, those described in United States Patent Application Publication 2003/0158316 A1 at [0047]-[0052], the cited portion of which being incorporated herein by reference. Suitable silicon-based polymers are defined in U.S. Pat. No. 6,623,791 at col. 9, lines 5-10, the cited portion of which being incorporated herein by reference.

As previously indicated, certain coating compositions of the present invention can include a film-forming binder that is formed from the use of a curing agent. As used herein, the term “curing agent” refers to a material that promotes “cure” of composition components. As used herein, the term “cure” means that any crosslinkable components of the composition are at least partially crosslinked. In certain embodiments, the crosslink density of the crosslinkable components, i.e., the degree of crosslinking, ranges from 5 percent to 100 percent of complete crosslinking, such as 35 percent to 85 percent of complete crosslinking. One skilled in the art will understand that the presence and degree of crosslinking, i.e., the crosslink density, can be determined by a variety of methods, such as dynamic mechanical thermal analysis (DMTA) using a Polymer Laboratories MK III DMTA analyzer, as is described in U.S. Pat. No. 6,803,408, at col. 7, line 66 to col. 8, line 18, the cited portion of which being incorporated herein by reference.

Any of a variety of curing agents known to those skilled in the art may be used. For example exemplary suitable aminoplast and phenoplast resins are described in U.S. Pat. No. 3,919,351 at col. 5, line 22 to col. 6, line 25, the cited portion of which being incorporated herein by reference. Exemplary suitable polyisocyanates and blocked isocyanates are described in U.S. Pat. No. 4,546,045 at col. 5, lines 16 to 38; and in U.S. Pat. No. 5,468,802 at col. 3, lines 48 to 60, the cited portions of which being incorporated herein by reference. Exemplary suitable anhydrides are described in U.S. Pat. No. 4,798,746 at col. 10, lines 16 to 50; and in U.S. Pat. No. 4,732,790 at col. 3, lines 41 to 57, the cited portions of which being incorporated herein by reference. Exemplary suitable polyepoxides are described in U.S. Pat. No. 4,681,811 at col. 5, lines 33 to 58, the cited portion of which being incorporated herein by reference. Exemplary suitable polyacids are described in U.S. Pat. No. 4,681,811 at col. 6, line 45 to col. 9, line 54, the cited portion of which being incorporated herein by reference. Exemplary suitable polyols are described in U.S. Pat. No. 4,046,729 at col. 7, line 52 to col. 8, line 9 and col. 8, line 29 to col. 9, line 66, and in U.S. Pat. No. 3,919,315 at col. 2, line 64 to col. 3, line 33, the cited portions of which being incorporated herein by reference. Examples suitable polyamines described in U.S. Pat. No. 4,046,729 at col. 6, line 61 to col. 7, line 26, and in U.S. Pat. No. 3,799,854 at column 3, lines 13 to 50, the cited portions of which being incorporated herein by reference. Appropriate mixtures of curing agents, such as those described above, may be used. Moreover, the appropriate selection of the functional groups of the curing agent and that of the complementary polymer is readily determined by those of ordinary skill in the art.

In certain embodiments, the coating compositions of the present invention are formulated as a one-component composition where a curing agent is admixed with other composition components to form a storage stable composition. In other embodiments, compositions of the present invention can be formulated as a two-component composition where a curing agent is added to a pre-formed admixture of the other composition components just prior to application.

As indicated, in certain embodiments the film-forming binder comprises a material that is curable upon exposure to actinic radiation, i.e., a radiation-curable binder. “Actinic radiation” is light with wavelengths of electromagnetic radiation ranging from gamma rays to the ultraviolet (“UV”) light range, through the visible light range, and into the infrared range. Actinic radiation which can be used to cure certain coating compositions of the present invention generally has wavelengths of electromagnetic radiation ranging from 100 to 2,000 nanometers (nm), can range from 180 to 1,000 nm, and also can range from 200 to 500 nm. Examples of suitable ultraviolet light sources include mercury arcs, carbon arcs, low, medium or high pressure mercury lamps, swirl-flow plasma arcs and ultraviolet light emitting diodes. Preferred ultraviolet light-emitting amps are medium pressure mercury vapor lamps having outputs ranging from 200 to 600 watts per inch (79 to 237 watts per centimeter) across the length of the lamp tube. For example, a 5 micrometer thick wet film of a 100% solids (described below) coating composition according to the present invention can be cured through its thickness to a tack-free state upon exposure to actinic radiation by passing the film at a rate of 20 to 1000 feet per minute (6 to 300 meters per minute) under two to four medium pressure mercury vapor lamps of exposure at 200 to 1000 millijoules per square centimeter of UVA energy.

Materials that are curable upon exposure to actinic radiation include compounds with radiation-curable functional groups, such as unsaturated groups, including vinyl groups, vinyl ether groups, epoxy groups, maleimide groups, fumarate groups and combinations of the foregoing. In certain embodiments, the radiation curable groups are curable upon exposure to ultraviolet radiation and can include, for example, acrylate groups, maleimides, fumarates, and vinyl ethers. Suitable vinyl groups include those having unsaturated ester groups and vinyl ether groups.

In certain embodiments, the radiation-curable compositions of the present invention comprise a soft type urethane (meth)acrylate polymer. As used herein, the term “(meth)acrylate” is meant to encompass acrylates and methacrylates. As used herein, the term “urethane (meth)acrylate polymer” refers to a polymer that has (meth)acrylate functionality and that contains a urethane linkage. As will be appreciated, such a polymer can be prepared, for example, by reacting a polyisocyanate, a polyol, and an (meth)acrylate having hydroxy groups, such as is described in U.S. Pat. No. 6,899,927 at col. 4, lines 4 to 49, the cited portion of which being incorporated herein by reference.

As used herein, the term “soft type urethane (meth)acrylate polymer” refers to a flexible urethane (meth)acrylate polymer that is the reaction product of a polyol and a polyisocyanate having relatively few functional groups per molecule, often two functional groups per molecule. In many cases, the soft type urethane (meth)acrylate polymer is a difunctional aliphatic urethane (meth)acrylate polymer in which, for example, (meth)acrylate groups are present at each terminal end of the urethane polymer. In some cases, such a polymer has a molecular weight of 3,000. Another example of a “soft type urethane (meth)acrylate polymer” is described in U.S. Pat. No. 6,899,927 at col. 4, line 50 to col. 5, line 3.

In certain embodiments, the soft-type urethane (meth)acrylate polymer is present in the coating compositions of the present invention in an amount of at least 10 percent by weight, such as at least 20 percent by weight, with the weight percents being based on the total weight of the composition. In certain embodiments, the soft-type urethane (meth)acrylate polymer is present in the coating compositions of the present invention in an amount of no more than 50 percent by weight, such as no more than 40 percent by weight, with the weight percents being based on the total weight of the composition. The amount of soft type urethane (meth)acrylate polymer in the compositions of the present invention can range between any combination of the recited values inclusive of the recited values.

In certain embodiments, the radiation-curable compositions of the present invention comprise a mono functional (meth)acrylate monomer and/or polymer. As used herein, the term “mono functional (meth)acrylate monomer and/or polymer” encompasses monomers and polymers comprising one (meth)acrylate group.

In certain embodiments, the mono functional (meth)acrylate monomer and/or polymer is present in the coating compositions of the present invention in an amount of at least 10 percent by weight, such as at least 20 percent by weight, with the weight percents being based on the total weight of the composition. In certain embodiments, the mono functional (meth)acrylate monomer and/or polymer is present in the coating compositions of the present invention in an amount of no more than 70 percent by weight, such as no more than 60 percent by weight, with the weight percents being based on the total weight of the composition. The amount of the mono functional (meth)acrylate monomer and/or polymer in the compositions of the present invention can range between any combination of the recited values inclusive of the recited values.

In certain embodiments, the radiation curable coating compositions of the present invention can further comprise multi-functional (meth)acrylate monomers and/or polymers, such as di-functional, tri-functional, tetra and/or higher functional (meth)acrylates. In certain embodiments, the radiation curable coating compositions of the present invention also comprise a heterocyclic vinyl compound, such as, for example, N-vinyl-2-pyrrolidone, N-vinyl-2-piperidone, N-vinyl-ε-caprolactam, N-vinyl-5-methyl-2-pyrrolidone, N-vinyl-3,3,5-trimethyl-2-pyrrolidone, N-vinyl-3-methyl-2-pyrrolidone, isomers, derivatives and mixtures thereof.

In certain embodiments, the film-forming binder is present in the coating compositions of the present invention in an amount greater than 30 weight percent, such as 40 to 90 weight percent, or, in some cases, 50 to 90 weight percent, with weight percent being based on the total weight of the coating composition. When a curing agent is used, it may, in certain embodiments, be present in an amount of up to 70 weight percent, such as 10 to 70 weight percent; this weight percent is also based on the total weight of the coating composition. The amount of film-forming binder in the compositions of the present invention can range between any combination of the recited values inclusive of the recited values.

As previously indicated, the coating compositions of the present invention comprise a particulate material consisting essentially of elemental silicon. Such particulate materials can be, for example, in powder form or pieces. In certain embodiments of the present invention, the average particle size of such particulates is 0.2 to 10 microns, such as 1 to 5 microns. The size of the silicon particulates used can be determined based on, for example, the desired thickness of the coating layer.

Silicon particulates are commercially available in a number of grades, such as technical grade, high purity and ultra-fine purity. High purity silicon is a waste product of wafer production in the electronics industry and is readily available. Suitable commercially available products include SI1059 and SI2105 (>97% silicon), available from Elkem and SI-100 from AEE (99.2% silicon). As used herein, the phrase “particulate material consisting essentially of elemental silicon” refers to particulate material comprising at least 95 percent by weight elemental silicon, such as at least 97 percent by weight elemental silicon, in some cases at least 99 percent by weight elemental silicon, or, in some cases, at least 99.9 percent by weight elemental silicon.

In certain embodiments of the present invention, the weight ratio of the foregoing silicon particulates to the organic film-forming binder in the coating compositions of the present invention is from 0.05 to 1:1, such as at least 0.1:1. The weight ratio of the silicon particulates to the organic film-forming binder in the compositions of the present invention can range between any combination of the recited values inclusive of the recited values.

The coating compositions of the present invention also comprise a non-conductive filler. As used herein, the term “non-conductive filler” refers to fillers that are neither conductive fillers nor semi-conductive fillers, as defined below. Examples of suitable non-conductive filler materials include calcium carbonate; magnesium carbonate; metal oxides, such as aluminum (alumina), antimony, iron, magnesium, molybdenum, silicon (silica), titanium and/or zirconium oxides; mica; talc; kaolin; clay; celite; asbestos; montmorillomite; bentonite; graphite; pumice powder; perlite; barite; quartz sand; silicon carbide; boron fibers; boron nitride; dolomite; hollow balloons; glass; aluminum hydroxide; barium sulfate; calcite; calcium sulfate; calcium sulfite; calcium silicate; potassium titanate; molybdenum sulfide; polyethylene fiber; polyester fiber; and aramid fiber.

In certain embodiments, the non-conductive filler present in the coating compositions of the present invention comprises, in addition to or in lieu of any of the previously described non-conductive fillers, a conventional non-chrome corrosion resisting filler. Suitable conventional non-chrome corrosion resisting fillers include, but are not limited to, zinc phosphate, calcium ion-exchanged silica, colloidal silica, synthetic amorphous silica, and molybdates, such as calcium molybdate, zinc molybdate, barium molybdate, strontium molybdate, and mixtures thereof. Suitable calcium ion-exchanged silica is commercially available from W.R. Grace & Co. as SHIELDEX® AC3 and/or SHIELDEX® C303. Suitable amorphous silica is available from W.R. Grace & Co. under the tradename SYLOID®. Suitable zinc phosphate is commercially available from Heubach as HEUCOPHOS ZP-10.

In certain embodiments, the non-conductive filler is present in the coating compositions of the present invention in an amount of at least 1 percent by weight, such as at least 10 percent by weight, with the weight percents being based on the total weight of the composition. In certain embodiments, the non-conductive filler is present in the coating compositions of the present invention in an amount of no more than 60 percent by weight, such as no more than 50 percent by weight, with the weight percents being based on the total weight of the composition. The amount of non-conductive filler in the compositions of the present invention can range between any combination of the recited values inclusive of the recited values.

In certain embodiments of the present invention, the weight ratio of the foregoing non-conductive filler to the foregoing silicon particulates in the coating compositions of the present invention is at least 1:1, such as from 1 to 10:1. The weight ratio of the non-conductive filler to the silicon particulates in the compositions of the present invention can range between any combination of the recited values inclusive of the recited values.

In certain embodiments of the present invention, the weight ratio of the combination of the non-conductive filler and silicon particulates to the film-forming resin in the coating compositions of the present invention is at least 0.05:1, such as at least 0.5:1, or in some cases, 0.5 to 2:1. The weight ratio of the combination of the non-conductive filler and the silicon particulates to the film-forming resin in the compositions of the present invention can range between any combination of the recited values inclusive of the recited values.

In certain embodiments, the coating compositions of the present invention are substantially, or, in some cases, completely free of conductive filler. As used herein, the term “conductive filler” refers to a filler that, on a molecular scale, has a partially filled band of “energy equivalent” molecular orbitals. This partially filled band has many “unpaired” electrons that are able to move freely from atom to atom within the conductive pigment matrix. The free flow of electrons within the matrix produces an electric current. Conductive fillers are distinguished from semi-conductive fillers, such as the elemental silicon described earlier, which are substances having two separate bands of “energy equivalent” molecular orbitals that are very close in energy. The lower energy band is completely filled with “paired” electrons and the higher energy band is completely empty of electrons. Since the energy gap between the two bands is very small, thermal energy can promote electrons from the lower filled band to the higher unfilled band producing band(s) that have small numbers of unpaired electrons, which in turn permits the establishment of a weak electric current. Examples of conductive fillers are zinc, aluminum, graphite, iron phosphide, tungsten, carbon black, iron, and/or stainless steel.

In certain embodiments, the coating compositions are substantially free or, in some cases, completely free of chromium-containing materials, i.e., contain less than about 2 weight percent of chromium-containing materials (expressed as CrO₃), less than about 0.05 weight percent of chromium-containing materials, or about 0.00001 weight percent or, in some cases, no chromium-containing materials. Examples of chromium-containing materials include chromic acid, chromium trioxide, chromic acid anhydride, dichromate salts such as ammonium dichromate, sodium dichromate, potassium dichromate, and calcium chromate. In another embodiment, the present compositions contain no zeolite.

In certain embodiments, the coating compositions of the present invention are substantially or, in some cases, completely free of a compound of the general formula Mₙ(X)ₘ, in which M is at least one central atom selected from the group of Lewis acceptors; X stands for Lewis donor ligands having at least one bridging atom selected from elements of main groups 5 and 6 of the periodic table of the elements; n is from 1 to 500; and m is from 3 to 2000, as described in United States Patent Application Publication 2005/0065269 at [0009] to [0014] and [0021] to [0033]. In these embodiments, the weight ratio of the combination of the non-conductive filler and silicon particulates to the foregoing compound is greater than 15:1, in some cases, greater than 20:1, and, in yet other cases, greater than 50:1.

In certain embodiments, the coating compositions of the present invention are in the form of liquid coating compositions, examples of which include aqueous and solvent-based coating compositions, as well as substantially or completely solvent-free and water-free liquid coating compositions (100% solids system), as well as substantially or completely solvent-free and water-free coating compositions that are a solid particulate form, i.e., a powder coating composition. Regardless of the form, the coating compositions of the present invention may be used alone or in combination as primers, basecoats, or topcoats. Certain embodiments of the present invention are directed to metal substrate primer coating compositions. As used herein, the term “primer coating composition” refers to coating compositions from which an undercoating may be deposited onto a substrate in order to prepare the surface for application of a protective or decorative coating system. Metal substrates that may be coated with such compositions include, for example, substrates comprising steel (including electrogalvanized steel, cold rolled steel, hot-dipped galvanized steel, among others), aluminum, aluminum alloys, zinc-aluminum alloys, steel coated with a zinc-aluminum alloy, and aluminum plated steel.

The metal substrate primer coating compositions of the present invention may be applied to bare metal. By “bare” is meant a virgin material that has not been treated with any pretreatment compositions, such as, for example, conventional phosphating baths, heavy metal rinses, etc. Additionally, bare metal substrates being coated with the primer coating compositions of the present invention may be a cut edge of a substrate that is otherwise treated and/or coated over the rest of its surface.

Before applying a primer coating composition of the present invention and/or a metal pretreatment composition of the present invention, the metal substrate to be coated may first be cleaned to remove grease, dirt, or other extraneous matter. Conventional cleaning procedures and materials may be employed. These materials could include, for example, mild or strong alkaline cleaners, such as those that are commercially available, such as Parco-Cleaner 338, commercially available from Henkel. The application of such cleaners may be followed and/or preceded by a water rinse.

The metal surface may then be rinsed with, for example, water and dried. Then, in certain embodiments, the metal surface may be brought into contact with a metal substrate pretreatment composition, such as a phosphate and/or titanium based pretreatment, among others, before contact with a coating composition of the present invention.

Certain embodiments of the present invention, particularly the metal substrate primer compositions, are directed to coating compositions comprising an adhesion promoting component. As used herein, the term “adhesion promoting component” refers to any material that is included in the composition to enhance the adhesion of the coating composition to a metal substrate.

In certain embodiments of the present invention, such an adhesion promoting component comprises a free acid. As used herein, the term “free acid” is meant to encompass organic and/or inorganic acids that are included as a separate component of the compositions of the present invention as opposed to any acids that may be used to form a polymer that may be present in the composition. In certain embodiments, the free acid included within the coating compositions of the present invention is selected from tannic acid, gallic acid, phosphoric acid, phosphorous acid, citric acid, malonic acid, a derivative thereof, or a mixture thereof. Suitable derivatives include esters, amides, and/or metal complexes of such acids.

In certain embodiments, the free acid comprises an organic acid, such as tannic acid, i.e., tannin. Tannins are extracted from various plants and trees which can be classified according to their chemical properties as (a) hydrolyzable tannins, (b) condensed tannins, and (c) mixed tannins containing both hydrolyzable and condensed tannins. Tannins useful in the present invention include those that contain a tannin extract from naturally occurring plants and trees, and are normally referred to as vegetable tannins. Suitable vegetable tannins include the crude, ordinary or hot-water-soluble condensed vegetable tannins, such as Quebracho, mimosa, mangrove, spruce, hemlock, gabien, wattles, catechu, uranday, tea, larch, myrobalan, chestnut wood, divi-divi, valonia, summac, chinchona, oak, etc. These vegetable tannins are not pure chemical compounds with known structures, but rather contain numerous components including phenolic moieties such as catechol, pyrogallol, etc., condensed into a complicated polymeric structure.

In certain embodiments, the free acid comprises a phosphoric acid, such as a 100 percent orthophosphoric acid, superphosphoric acid or the aqueous solutions thereof, such as a 70 to 90 percent phosphoric acid solution.

In addition to or in lieu of such free acids, other suitable adhesion promoting components are organophosphates, and organophosphonates. Suitable organophosphates and organophosphonates include those disclosed in U.S. Pat. No. 6,440,580 at col. 3, line 24 to col. 6, line 22, U.S. Pat. No. 5,294,265 at col. 1, line 53 to col. 2, line 55, and U.S. Pat. No. 5,306,526 at col. 2, line 15 to col. 3, line 8, the cited portions of which being incorporated herein by reference. Metal phosphate adhesion promoting components may also be used, so long as the resulting coating composition remains non-electrically conductive and, in at least some cases, remains flexible enough to be suitable for use in coil coating applications. Suitable metal phosphates include, for example, zinc phosphate, iron phosphate, manganese phosphate, calcium phosphate, magnesium phosphate, cobalt phosphate, zinc-iron phosphate, zinc-manganese phosphate, zinc-calcium phosphate, including the materials described in U.S. Pat. Nos. 4,941,930, 5,238,506, and 5,653,790.

In certain embodiments, the adhesion promoting component comprises a phosphatized epoxy resin. Such resins may comprise the reaction product of one or more epoxy-functional materials and one or more phosphorus-containing materials. Non-limiting examples of such materials, which are suitable for use in the present invention, are disclosed in U.S. Pat. No. 6,159,549 at col. 3, lines 19 to 62, the cited portion of which being incorporated by reference herein, as well as U.S. Pat. No. 7,147,897 at col. 2, line 13 to col. 4, line 5, the cited portion of which being incorporated herein by reference.

In certain embodiments, the adhesion promoting component is present in the coating compositions of the present invention in an amount ranging from 0.05 to 20 percent by weight, such as 3 to 15 percent by weight, with the percents by weight being based on the total weight of the composition.

In certain embodiments, the coating compositions of the present invention may also comprise additional optional ingredients, such as those ingredients well known in the art of formulating surface coatings. Such optional ingredients may comprise, for example, surface active agents, flow control agents, thixotropic agents, fillers, anti-gassing agents, organic co-solvents, catalysts, antioxidants, light stabilizers, UV absorbers and other customary auxiliaries. Any such additives known in the art can be used, absent compatibility problems. Non-limiting examples of these materials and suitable amounts include those described in U.S. Pat. Nos. 4,220,679; 4,403,003; 4,147,769; and 5,071,904.

In certain embodiments, the compositions of the present invention comprise a colorant. As used herein, the term “colorant” means any substance that imparts color and/or other opacity and/or other visual effect to the composition. The colorant can be added to the coating in any suitable form, such as discrete particles, dispersions, solutions and/or flakes. A single colorant or a mixture of two or more colorants can be used in the coatings of the present invention.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated into the coatings by use of a grind vehicle, such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as pthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167 filed Jun. 24, 2003, and U.S. patent application Ser. No. 11/337,062, filed Jan. 20, 2006, which is also incorporated herein by reference.

Example special effect compositions that may be used in the compositions of the present invention include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In a non-limiting embodiment, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In general, the colorant can be present in any amount sufficient to impart the desired visual and/or color effect. The colorant may comprise from 1 to 65 weight percent of the present compositions, such as from 3 to 40 weight percent or 5 to 35 weight percent, with weight percent based on the total weight of the compositions of the present invention.

As previously indicated, the coating compositions of the present invention are non-weldable, which, as used herein, means that the various components of the coating composition are present in amounts such that the coating composition, when deposited upon a substrate and cured, produces a non-weldable coating. As used herein, the phrase “non-weldable coating” means that when conducting spot weld testing of a substrate coated with a coating, the life of a 5.5 mm (F16) electrode welding tip is less than 100 welds when tested according to the procedure to described in the Examples herein.

The coating compositions of the present invention can be prepared by any suitable technique, including those described in the Examples herein. The coating components can be mixed using, for example, stirred tanks, dissolvers, including inline dissolvers, bead mills, stirrer mills, static mixers, toothed wheel dispersers or extruders. Where appropriate, it is carried out with exclusion of actinic radiation in order to prevent damage to the coating of the invention which is curable solely or additionally with actinic radiation. In the course of preparation, the individual constituents of the mixture according to the invention can be incorporated separately. Alternatively, the mixture of the invention can be prepared separately and mixed with the other constituents.

In certain embodiments, the coating compositions of the present invention are suitable for use as a coil coating. Coil coating starts from a coil of metal which has conventionally been cleaned, degreased, passivated, chemically treated, rinsed, and dried. The metal coil can be coated on one or both sides. Suitable metals include those from which it is possible to form coils which are equal to the mechanical, chemical, and thermal stresses of the coil coating. Highly suitable metal coils are those based on aluminum or iron, such as cold-rolled steels, electrolytically zinc-plated steels, hot-dip galvanized steels, stainless steels, or steels coated with a zinc-aluminum alloy. In certain embodiments, the metal sheets of the coils have a thickness of from 200 μm to 2 mm.

In a coil coating operation, as will be appreciated by those skilled in the art, the metal coil passes through a coil coating line at a speed adapted to the application and curing properties of the coatings that are employed. The speed may therefore vary very widely from one coating process to another. In certain embodiments, the line speed is from 10 to 200, such as 12 to 150, 16 to 120, or from 20 to 100 m/min.

The coatings of the invention may be applied in any desired manner; for example, by spraying, flowcoating or roller coating. Of these application techniques, roller coating can be particularly advantageous and is therefore often used. Each application step in roller coating may be conducted using two or more rolls.

In roller coating, the rotating pickup roll dips into a reservoir of the coating of the invention and so picks up the coating to be applied. This coating is transferred by the pickup roll, directly or via at least one transfer roll, to the rotating application roll. From this latter roll, the coating is transferred onto the coil by means of codirectional or counterdirectional contact transfer. Alternatively, the coating of the invention may be pumped directly into a gap or nip between two rolls, this being referred to by those in the art as nip feed.

In roller coating, the peripheral speeds of the pickup roll and application roll may vary very greatly from one coating process to another. The application roll preferably has a peripheral speed which is from 110 to 125% of the coil speed, and the pickup roll preferably has a peripheral speed which is from 20 to 40% of the coil speed.

The coatings of the invention are often applied in a wet film thickness such that curing of the coating films results in coatings which are non-weldable and have a dry film thickness greater than 2.2 μm, such as from 4 to 12 μm, in some cases from 5 to 10 μm, in some cases from 5 to 9.5 μm, and, in other cases, from 6 to 9 μm.

The application methods described above can be employed with the coating materials with which the coatings of the invention are overcoated, except where they are powder coating materials or electrocoat materials, for which the customary and known, special application methods are used, such as electrostatic powder spraying in the case of low-speed coils or the powder cloud chamber process in the case of high-speed coils, and cathodic electrodeposition coating.

In the case of heat curing, heating of the coating films of the invention often takes place by means of convective heat transfer, irradiation with near or far infrared and/or, in the case of iron-based coils, by means of electrical induction. The maximum substrate temperature is often 270° C., such as 260° C.

The heating time, i.e., the duration of the heat cure, varies depending on the coating of the invention that is used. It is often from 10 seconds to 2 minutes.

Thermal curing of the coating films of the invention may also be assisted by exposure to actinic radiation.

Alternatively, depending on the particular composition used, curing may take place with actinic radiation alone, as described earlier and as is illustrated in the Examples herein.

The curing methods described above can of course also be used for the coating films with which the coatings of the invention are overcoated.

If two or more coating materials are applied during the coil coating operation, this is carried out in an appropriately configured line, in which two or more applications and, where appropriate, curing stations are interposed in series. Alternatively, following application and curing of the first coating material, i.e., the coating of the invention, the coated coil is wound up again and is then provided on one or both sides with second, third, etc. coatings in a second, third, etc. coil coating line.

Following the production of the coated coils, they can be wound up and then processed further at another place; alternatively, they can be processed further as they come directly from the coil coating operation. For instance, they may be laminated with plastics or provided with removable protective films. After cutting into appropriately sized parts, they may be shaped. Examples of suitable shaping methods include pressing and deep drawing.

The resultant coils, profile elements, and moldings of the invention are scratch resistant, corrosion stable, weathering stable, and chemicals stable, and can be overcoated with any of a wide variety of coating materials.

It was surprisingly discovered that a substrate coated with a coating composition of the present invention exhibits favorable corrosion resistance properties, even in some cases in which conventional corrosion resisting fillers, such as those described herein, are not used in the composition. Moreover, there is no need for chromate pretreatment of the metal coils in order to obtain desirable corrosion protection. As used herein, the term “corrosion resistance properties” refers to the measurement of corrosion prevention on a metal substrate utilizing the test described in ASTM B117 (Salt Spray Test). In this test, the coated substrate is scribed with a knife to expose the bare metal substrate. The scribed substrate is placed into a test chamber where an aqueous salt solution is continuously misted onto the substrate. The chamber is maintained at a constant temperature. The coated substrate is exposed to the salt spray environment for a specified period of time, such as 500 or 1000 hours. After exposure, the coated substrate is removed from the test chamber and evaluated for corrosion along the scribe. Corrosion is measured by “scribe creep”, which is defined as the total distance the corrosion has traveled across the scribe measured in millimeters.

Illustrating the invention are the following examples, which, however, are not to be considered as limiting the invention to their details. Unless otherwise indicated, all parts and percentages in the following examples, as well as throughout the specification, are by weight.

### EXAMPLES

### Example 1

Coating compositions were prepared using the components and weights (in grams) shown in Table 1. Coatings were prepared by adding components 1 to 9 to a suitable vessel under agitation with a blade and mix with zircoa beads for approximately 30 minutes to achieve a 7 Hegman. Next, components 10 to 14 were added while under agitation and left to mix for 10 minutes. After mixing the coating the milling beads were filtered out with a standard paint filter and the finished material was ready for application.

TABLE 1

| Component | | Exam- | Exam- | Exam- | Exam- |
|---|---|---|---|---|---|
| No. | Material | ple 1 | ple 2 | ple 3 | ple 4 |
| 1 | Polyester Resin¹ | 23.1 | 23.1 | 23.1 | 23.1 |
| 2 | Phosphatized | 8.1 | 8.1 | 8.1 | 8.1 |
| | Epoxy² | | | | |
| 3 | Solvesso 100³ | 30.0 | 30.0 | 30.0 | 30.0 |
| 4 | Butyl Cellosolve⁴ | 30.0 | 30.0 | 30.0 | 30.0 |
| 5 | Ti-Pure R960⁵ | 22.2 | 22.2 | 22.2 | 22.2 |
| 6 | ASP-200 Clay⁶ | 33.1 | 33.1 | 33.1 | 33.1 |
| 7 | Shieldex C303⁷ | 23.1 | 30.6 | — | — |
| 8 | Hecuophos ZP-10⁸ | 13.8 | — | 13.8 | — |
| 9 | SI-1059⁹ | — | — | 29.6 | 39.1 |
| 10 | Polyester Resin¹ | 98.2 | 98.2 | 98.2 | 98.2 |
| 11 | Cymel 1123¹⁰ | 16.3 | 16.3 | 16.3 | 16.3 |
| 12 | Solvesso 100³ | 17.0 | 17.0 | 17.0 | 17.0 |
| 13 | N-Butanol¹¹ | 3.0 | 3.0 | 3.0 | 3.0 |
| 14 | CYCAT 4040¹² | 0.5 | 0.5 | 0.5 | 0.5 |

¹Polyester resin prepared by adding Charge #1 (827.6 grams 2-methyl 1,3-propanediol, 47.3 grams trimethylol propane, 201.5 grams adipic acid, 663.0 grams isophthalic acid, and 591.0 grams phthalic anhydride) to a round-bottomed, 4-necked flask equipped with a motor driven stainless steel stir blade, a packed column connected to a water cooled condenser and a heating mantle with a thermometer connected througha temperature feed-back control device. The reaction mixture was heated to 120° C. in a nitrogen atmosphere. All components were melted when the reaction mixture reached 120° C. and the reaction was then heated to 170° C. at which temperature the water generated by the esterification reaction began to be collected. The reaction temperature was maintained at 170° C. until the distillation of water began to significantly slow, atwhich point the reaction temperature was increased by 10° C. This stepwise temperature increase was repeated until the reaction temperature reached 240° C. When the distillation of water at 240° C. stopped, the reaction mixture was cooled to 190° C., the packed column replaced with a Dean-Stark and a nitrogen sparge was started. Charge #2 (100.0 grams Solvesso 100 and 2.5 grams titanium (IV) tetrabutoxide) was added and thereaction was heated to reflux (~220° C.) with continuous removal of the water collected in the Dean-Stark trap. The reaction mixture was held at reflux until the measured acid value was less than 8.0 mg KOH/gram. The resin was cooled, thinned with Charge #3 (1000.0 grams Solvesso 110), discharged and analyzed. The determined acid value was 5.9 mg KOH/gram, and the determined hydroxy value of 13.8 mg KOH/gram. Thedetermined non-volatile content of the resin was 64.1% as measured by weight loss of a sample heated to 110° C. for 1 hour. Analysis of the polymer by GPC (using linear polystyrene standards) showed the polymer to have an M_{w} value of 17,788, Mₙ value of 3,958, and an M_{w}/Mₙ value of 4.5.
²Phosphatized epoxy resin prepared by dissolving 83 parts by weight of EPON 828 epoxy resin (a polyglycidyl ether of bisphenol A, commercially available from Resolution Performance Products) in 20 parts by weight 2-butoxyethanol. The epoxy resin solution was subsequently added to a mixture of 17 parts by weight of phosphoric acid and 25 parts by weight 2-butoxyethanol under nitrogen atmosphere. The blend wasagitated for about 1.5 hours at a temperature of about 115° C. to form a phosphatized epoxy resin. The resulting resin was further diluted with 2-butoxyethanol to produce a composition which was about 55 percent by weight solids.
³Commercially available from Exxon.
⁴Commercially available from Dow Chemical.
⁵Rutile titanium dioxide commercially available from DuPont.
⁶Clay commercially available from Engelhard Corp.
⁷Calcium ion-exchanged silica commercially available from Grace.
⁸Zinc phosphate hydrate commercially available from Heubach.
⁹Silicon particles commercially available from Elkem.
¹⁰Benzoguanamine resin commercially available from Cytec.
¹¹Commercially available from Exxon.
¹²PTSA solution commercially available from King Industries.

### Test Substrate Preparation

The coating compositions of Table 1 were applied over G90 HDG steel pretreated with Bonderite® 1455 (commercially available from Henkel Surface Technologies) using a wire wound drawdown bar. Each primer composition was applied at approximately 0.2 mils dry film thickness and cured in a gas-fired oven for 30 seconds at 450° F. peak metal temperature. Subsequently, a coil topcoat (Durastar™ HP 9000 commercially available from PPG Industries) was applied over the primer with a wire wound drawdown bar at approximately 0.75 mils dry film thickness and cured in a gas fired oven for 30 seconds at 450° F. peak metal temperature.

### Salt Spray Results

Salt spray panels were prepared by cutting a panel to approximately 4 inches wide and 5 inches long. The left and right edges were cut down with a metal shear. The face of the panels were scribed in the middle with a vertical and horizontal scribe approximately 1.5 inches long and separated by approximately 0.5 inches. This is achieved with a tungsten tip tool and extends down just through the organic coating.

Salt spray resistance was tested as described in ASTM B117. Panels were removed from salt spray testing after 500 hours. Immediately after salt spray the panels were washed with warm water, scribes and cut edges were scraped with a wooden spatula to remove salt build-up and then dried with a towel. After which panels were taped with Scotch 610 tape to remove blistered coating.

Panels were evaluated for face blistering, cut edge creep, and scribe creep. Face blistering was measured according to ASTM D714-87. The cut edge values were reported as an average of the maximum creep on the left and right cut edges in millimeters. The scribe creep values were reported as an average of the maximum creep (from scribe to creep) on the vertical and horizontal scribes in millimeters. Results are illustrated in Table 2, with lower value indicated better corrosion resistance results.

TABLE 2

| G90 HDG Steel | | | | |
|---|---|---|---|---|
| Substrate | Example 1 | Example 2 | Example 3 | Example 4 |
| Face Blistering | None | None | None | None |
| Cut Edge | 5 | 4 | 5 | 2.5 |
| Scribe | <0.5 | 1 | <0.5 | 2 |

### Example 2

Coating compositions were prepared using the components and weights (in grams) shown in Table 2. Coatings were prepared by adding components 1 to 5 to a suitable vessel under agitation with a cowles blade for approximately 30 minutes to achieve a 5 Hegman. Next, components 6 to 8 were added while under agitation and left to mix for 10 minutes. After mixing the coating was ready for application.

TABLE 3

| Component No. | Material | Example 5 |
|---|---|---|
| 1 | 100% Solids Di-functional Aliphatic | 36.0 |
| | Urethane Acrylate Resin¹ | |
| 2 | SR-506 Isobornyl Acrylate² | 41.3 |
| 3 | SR-399³ | 5.5 |
| 4 | Shieldex C303⁴ | 45 |
| 5 | SI-1059⁵ | 15 |
| 6 | Darocure 1173⁶ | 9.8 |
| 7 | Ebecryl 171⁷ | 6.9 |
| 8 | BYK-302⁸ | 0.4 |

¹Available commercially from Sartomer, Cytec, or BASF.
²Commercially available from Sartomer.
³Dipentaerythritol Pentaacrylate commercially available from Sartomer.
⁴Calcium ion-exchanged silica commercially available from Grace.
⁵Silicon particles commercially available from Elkem.
⁶Photoinitiator commercially available from Ciba.
⁷Adhesion promoter commercially available from Cytec.
⁸Silicon surface additive commercially available from BYK.

### Test Substrate Preparation

The primer composition in Table 1 was applied over alkaline cleaned HDG steel using a wire wound drawdown bar. The primer composition was applied at approximately 0.2 mils dry film thickness and cured with a Fusion 600 watt/in H lamp. The energy and intensity output was 263 mJ/cm2 UVA and 1281mW/cm2 UVA (measured with an EIT Powerpuck). Subsequently, a coil topcoat (Durastar™ HP 7000 commercially available from PPG Industries) was applied over the primer with a wire wound drawdown bar at approximately 0.75 mils dry film thickness and cured in a gas fired oven for 30 seconds at 450° F. peak metal temperature.

### Salt Spray Results

Salt spray panels were prepared by cutting a panel to approximately 4 inches wide and 5 inches long. The left and right edges were cut down with a metal shear. The face of the panels were scribed in the middle with a vertical and horizontal scribe approximately 1.5 inches long and separated by approximately 0.5 inches. This is achieved with a tungsten tip tool and extends down just through the organic coating.

Salt spray resistance was tested as described in ASTM B117. Panels were removed from salt spray testing after 500 hours. Immediately after salt spray the panels were washed with warm water, scribes and cut edges were scraped with a wooden spatula to remove salt build-up and then dried with a towel. After which panels were taped with Scotch 610 tape to remove blistered coating.

Panels were evaluated for face blistering, cut edge creep, and scribe creep. Face blistering was measured according to ASTM D714-87. The cut edge values were reported as an average of the maximum creep on the left and right cut edges in millimeters. The scribe creep values were reported as an average of the maximum creep (from scribe to creep) on the vertical and horizontal scribes in millimeters. Results are illustrated in Table 4, with lower value indicated better corrosion resistance results.

TABLE 4

| HDG Steel Substrate | Example 5 |
|---|---|
| Face Blistering | None |
| Cut Edge | 5.5 |
| Scribe | 1.0 |

### Weld Testing

The coating compositions of Examples 3, 4, and 5 were applied on both sides of G90 HDG steel sheets pretreated with Bonderite® 1455 (commercially available from Henkel Surface Technologies) using a wire wound drawdown bar. Each primer composition was applied at approximately 0.2 mils dry film thickness and cured in a gas-fired oven for 30 seconds at 450° F. peak metal temperature. Efficiency of welding for each variable was determined in accordance with the test procedure FLTM BA 13-1 (Ford Laboratory test Method). The test determines the actual life of the 5.5 mm (F16) electrode welding tips. Welds are done in 100 weld increments. The first 90 welds are done at 0.1 kA below expulsion. Then ten coupons are welded and the nugget size of each weld is measured. The test continues until the average nugget diameter of a 10 coupon set is less 4 times the square root of t, where t is the thickness of one coupon. Results are shown in Table 5

TABLE 5

| HDG Steel Substrate | Example 3 | Example 4 | Example 5 |
|---|---|---|---|
| Number of welds¹ before average | Less than | Less than | 0 |
| nugget diameter of a ten coupon set is | 100 | 100 | |
| less than 4 * √t | | | |

¹The welding data included in Table 5 was evaluated using a model 150 AP resistance spot welder from Lors Corporation of Union, NJ, equipped with a Model 108B welding controller from Interlock Industries, Inc. and Lors Corporation. The welding current in kilo amperes (kA) was measured using a model MM-315A Weld Checker from Unitek Miyachi Corporation of Monrovia, California. MB 25Z copper welding tips from theWheaton Company, Inc. of Warminster, PA with a starting face diameter of 3/16 inch were used.

The data reported in Table 5 above shows that the coating compositions of the present invention have less than 100 welds and are typically not acceptable for automotive welding.

Whereas particular embodiments of this invention have been described above for purposes of illustration, it will be evident to those skilled in the art that numerous variations of the details of the present invention may be made without departing from the invention as defined in the appended claims.

We claim:

1. A coating composition comprising:
(a) a film-forming binder;
(b) a particulate material consisting essentially of elemental silicon; and
(c) a non-conductive filler, wherein
the coating composition is non-weldable.

2. The coating composition of claim 1, wherein the film-forming binder comprises a thermosetting film-forming resin.

3. The coating composition of claim 2, wherein the thermosetting film-forming resin comprises a self-crosslinking resin.

4. The coating composition of claim 1, wherein the film-forming binder comprises a saturated or unsaturated polyester.

5. The coating composition of claim 1, wherein the film-forming binder is curable upon exposure to actinic radiation.

6. The coating composition of claim 5, wherein the radiation curable film-forming binder comprises a soft type urethane (meth)acrylate polymer.

7. The coating composition of claim 1, wherein the weight ratio of silicon particulates to the organic film-forming binder in the coating composition is at least 0.1:1.

8. The coating composition of claim 1, wherein the non-conductive filler comprises titanium dioxide and/or a non-chrome corrosion resisting filler.

9. The coating composition of claim 1, wherein the weight ratio of the non-conductive filler to the silicon particulates in the coating compositions of the present invention is at least 1:1.

10. The coating composition of claim 1, wherein the weight ratio of the combination of the non-conductive filler and particulate material consisting essentially of elemental silicon to the film-forming resin is at least 0.5:1.

11. The coating composition of claim 1, further comprising an adhesion promoting component.

12. The coating composition of claim 11, wherein the adhesion promoting component comprises a phosphatized epoxy resin.

13. A substrate at least partially coated with a non-electrically conductive coating deposited from the coating composition of claim 1.

14. A method for coating a substrate, comprising:
(a) depositing onto at least a portion of the substrate a coating composition comprising:
(i) a film-forming binder;
(ii) a particulate material consisting essentially of elemental silicon; and
(iii) a non-conductive filler; and
(b) curing the composition to form a cured non-weldable coating having a dry film thickness of greater than 2.2 microns.

15. The method of claim 14, wherein the film-forming binder is radiation curable.

16. The method of claim 14, wherein the weight ratio of silicon particulates to the organic film-forming binder in the coating composition is at least 0.1:1.

17. The method of claim 14, wherein the non-conductive filler comprises titanium dioxide and/or a non-chrome corrosion resisting filler.

18. The method of claim 14, wherein the weight ratio of the non-conductive filler to the particulate material consisting essentially of elemental silicon in the coating composition is at least 1:1.

19. The method of claim 14, wherein the weight ratio of the combination of the non-conductive filler and particulate material consisting essentially of elemental silicon to the film-forming resin in the coating composition is at least 0.5:1.

20. The method of claim 14, wherein the coating composition further comprises an adhesion promoting component comprising a phosphatized epoxy resin.
